(19) United States
(12) Patent Application Publication
(10) Pub. No.: US 2020/0108413 A1
(43) Pub. Date: Apr. 9, 2020

(54) Recycled glass cleaner

(71) Applicants: Thomas J. Bierma, Fort Myers, FL (US); Guang Jin, Bloomington, IL (US)

(72) Inventors: Thomas J. Bierma, Fort Myers, FL (US); Guang Jin, Bloomington, IL (US)

(21) Appl. No.: 16/602,408

(22) Filed: Sep. 30, 2019

Related U.S. Application Data
(60) Provisional application No. 62/743,244, filed on Oct. 9, 2018.

(51) Int. Cl. B07B 4/02; B07B 13/00; B07B 4/08

(52) U.S. Cl. CPC B07B 4/02; B07B 2220/02; B07B 4/08; B07B 13/003

(57) ABSTRACT

Separation of mixed materials is accomplished by causing a stream of the materials to fall on an inclined separation ramp, while directing a stream of air onto the ramp. Lower-density materials having higher aerodynamic drag, such as paper scraps, are blown up and over the ramp into a first collection zone, while more dense materials having less aerodynamic drag, such as glass fragments, will tend to descend the ramp and fall into a separate collection zone.

### CROSS-REFERENCE TO RELATED APPLICATION

This application claims priority from Provisional Application Ser. No. 62/743,244, filed Oct. 9, 2018.

### FIELD OF THE INVENTION

This invention relates to separation of materials in a post-consumer waste stream, as a desirable aspect of recycling and disposal operations.

### BACKGROUND OF THE INVENTION

In recent years, much attention has been paid to the problem of recycling useful materials from post-consumer waste streams containing a wide variety of useful materials, such as metals and glass, as well as less directly reusable materials. See, for example, Andela reissue patent RE45,290, which is directed to production of clean glass particles from post-consumer waste streams. The Andela patent discusses a complete system for recovering glass from post-consumer waste, including numerous differing steps for separating out the various constituents of the stream. The present invention relates to a further improvements in methods and equipment for processing post-consumer waste streams, and may in particular provide a useful preliminary step to, or additional step in, the process described in the Andela patent.

More particularly, one persistent problem that is experienced in the employment of the Andela system and other existing technologies for cleaning up glass is that paper in the waste stream is often wet, and tends to act as a sort of papier-mâche, that is, it tends to adhere to the internal surfaces of the equipment and interfere with its proper operation. This reduces efficiency and requires additional cleaning and maintenance steps. The present invention has utility in removing some fraction of the paper from the incoming waste stream and can improve the efficiency of separation provided by the Andela system. The system of the invention may have applicability in other waste processing systems, as well.

### SUMMARY OF THE INVENTION

The present invention utilizes flowing air and gravity to separate a mix of solid materials into groups of component materials with similar density and aerodynamic drag. For example, recycled glass from single-stream recycling operations frequently contains a significant fraction of non-glass residue (NGR) commonly composed of paper, plastic, metal, and other materials. Much of the NGR material has a density and/or aerodynamic drag substantially different from glass, and thus can be separated from the glass utilizing the teachings disclosed herein.

In brief, and without limiting the invention, an air stream which is generally horizontally-aligned is directed at an inclined plane, defining a “separation ramp”. The material to be separated is caused to impact the separation ramp from above. The more dense materials having lesser aerodynamic drag, such as glass fragments, slide downwardly off the separation ramp into a “heavy side”, for subsequent collection and removal, while the less dense materials having greater aerodynamic drag, such as scraps of paper, are blown by the air stream up and over an upper edge of the separation ramp into a “light side”, for separate collection and removal. This invention is simple to implement and requires no moving parts. Further, there are no constricted spaces in the separation equipment that would be prone to clogging.

Certain conventional systems may implement an air stream separator (also called “air knife” or “vacuum”) that has limited separation ability because materials are not disentangled prior to presentation to the air stream. Further, conventional systems do not allow the material to spend an adequate amount of time in the air stream. More complex equipment (utilizing multiple air streams, various moving parts, having restricted spaces that tend to become clogged, etc.) can achieve greater separation of materials but with significantly higher capital and operating costs.

Accordingly, there is a need for a separator that is simpler and therefore both more reliable and more durable than the more complex equipment currently available. Further, there is a need for a separator that has few moving parts and requires less time for maintenance. Further, there is a need for a separator that has few restricted spaces in order to reduce the occurrence of clogs.

In the preferred embodiment of the invention, structure is provided for “disentangling” the materials prior to presenting them to the air stream.

### BRIEF DESCRIPTION OF THE DRAWINGS

The invention will be better understood if reference is made to the accompanying drawings, in which:

FIG. 1 is a schematic cross-sectional view of a first embodiment of a separator assembly for practicing the invention;

FIG. 2 is an enlarged side view of the impact zone in which the air stream impacts the inclined plane and waste stream;

FIG. 3 illustrates the disentanglement of waste according to the invention;

FIG. 4 is a view similar to FIG. 1, illustrating a second embodiment of the separator assembly of the invention;

FIG. 5 is a view similar to FIG. 1, illustrating a third embodiment of the separator assembly of the invention;

FIG. 6 is a view similar to FIG. 1, illustrating a fourth embodiment of the separator assembly of the invention;

FIG. 7 is a perspective view of a mechanism for controlling a cam;

FIG. 8 is an elevation view of the mechanism of FIG. 7; and

FIG. 9 is a cross-sectional view comparable to FIG. 8, showing the position of components allowing relative adjustment.

### DETAILED DESCRIPTION OF THE INVENTION

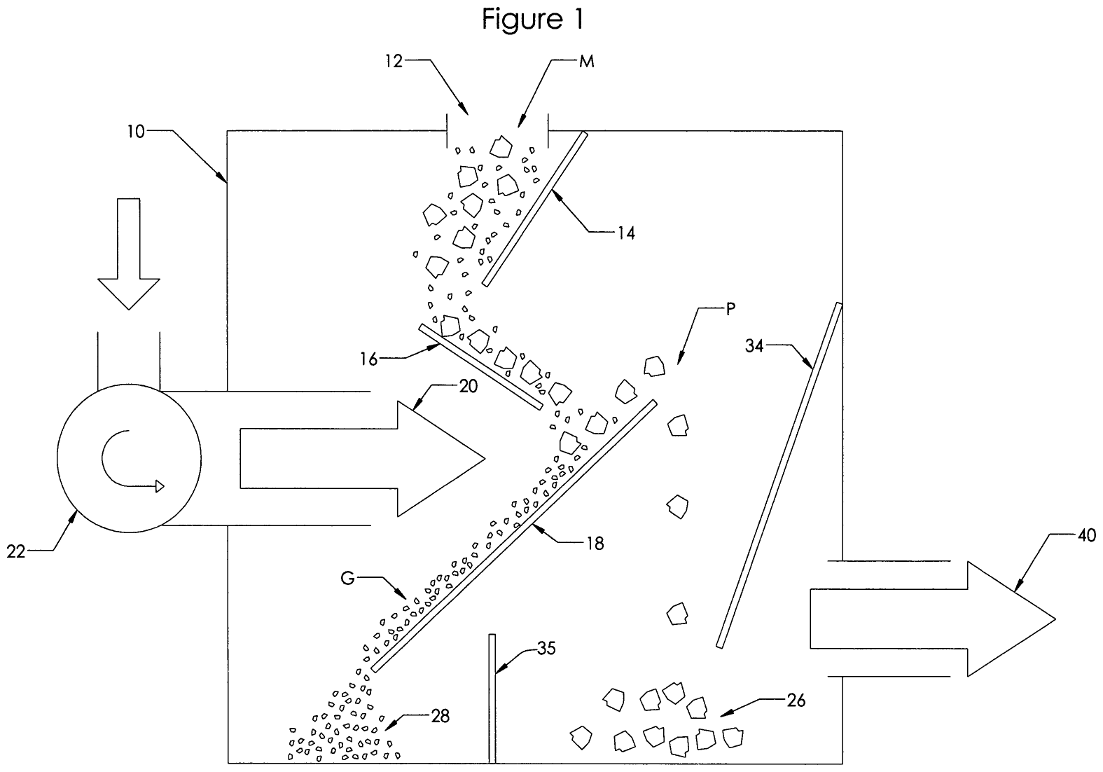

Referring now to FIG. 1, one embodiment of the separator of the invention 10 is illustrated in a schematic cross-sectional view. The separator 10 comprises a closed box with internal partitions as shown in cross-section in FIG. 1, and additional components as shown and described below. A stream of post-consumer waste of mixed material M enters the separator through an opening 12 in the top and then passes over a series of preparation ramps 14 and 16, which are inclined to the horizontal, as illustrated. The preparation ramps 14, 16 serve to disentangle the mixed materials M in a manner discussed below and provide a desired feed rate of the mixed material to a separation ramp 18.

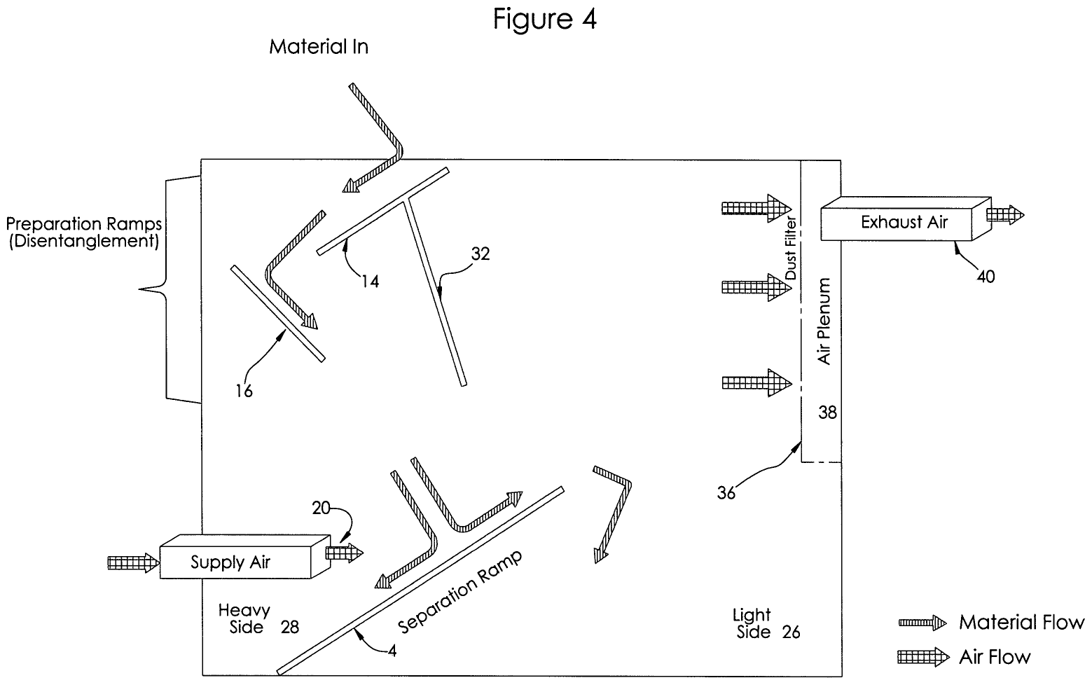

The mixed material M initially falls onto ramp 14, slides down ramp 14 and falls onto ramp 16. Additional ramps can be added after ramp 16 if needed; the invention contemplates utilizing more or less than two ramps, in varying configurations. See FIGS. 4-6. Several aspects of the preparation ramps 14 and 16 are variable, and the embodiments illustrated in this disclosure are only meant as non-exclusive examples. More specifically, the number of ramps, the angle of the ramps, the spacing between the ramps, which defines a “fall zone” between the ramps, the material composition of the ramps, and the width of the ramps may all be varied compared to the examples given herein. More specifically, the listed parameters, and others, may all vary depending upon the composition of the mixed material M to be separated, and the desired degree of separation. In general, greater disentanglement of the various components of the mixed material stream M from one another is desired, so that the separation performed according to the invention is more effective, and this greater disentanglement can be achieved by using more ramps, reduced ramp angle, larger gap (the “fall zone”) between the ramps, and more inelastic ramp material. The width of the ramps can be adjusted to achieve the desired flow pattern of material to a separation ramp 18, with wider ramps producing a lower feed rate per unit width of the ramp.

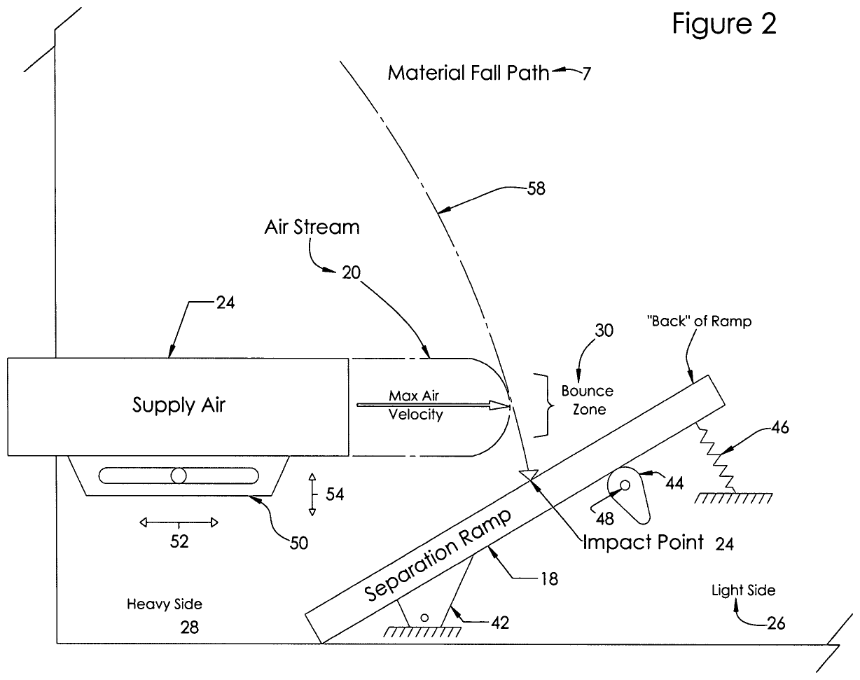

At the separation ramp 18, material falling from the last preparation ramp 16 is impacted by an air stream 20 supplied by an air supply, typically an industrial fan 22, before the material impacts the ramp 18. FIG. 2 shows this in more detail. The air stream 20 is positioned so that maximum air velocity occurs a short distance vertically above an impact point 24 on the ramp 18, at which the bulk of the material M to be separated impacts the separation ramp 18. Material with low density and high aerodynamic drag (such as scraps of paper P) may be swept up and over the separation ramp 18 to a “light side” region of the separator 10 before impacting the ramp 18. The remaining material will impact, and rebound from, the ramp surface. The magnitude of the rebound will depend, in part, on the composition of the material to be processed, as well as on the composition of the material of the ramp. For example, denser material of lower aerodynamic drag such as particles of glass G tends to rebound less than items made from plastic or metal. Materials with sufficient rebound will re-enter the zone of maximum air velocity within the air stream 20. Those with the lowest density and highest aerodynamic drag may be swept up and over the separation ramp 18 to the light side 26. The remaining material will slide down the ramp 18 to the heavy side 28. A further baffle 34 may be provided, to assist the lighter material in falling to the light side 26. Another baffle 35 may be provided to keep the materials separate.

Several aspects of the separation ramp 18 (see FIG. 2) are variable as well, including the distance of the gap (fall zone) between the final preparation ramp 16 and the separation ramp 18, the angle of the separation ramp 18 to the horizontal, the length of the separation ramp 18, the point of impact 24 of the materials to be separated on the separation ramp 18, the material composition of the separation ramp 18, the velocity of the air stream 20, the angle of the air stream 20 with respect to the separation ramp 18, the distance between the point of impact 24 and the region of the maximum velocity of the air stream 20, and the angle of the air stream 20 relative to the angle of the separation ramp 18. Optimization of each of these variables by experimentation is within the skill of the art. In general, more material will be swept up and over the separation ramp 18 if the angle of the ramp is lower, its length is shorter, the impact point 24 is higher (closer to the back of the ramp 18), and the air stream 20 velocity is higher.

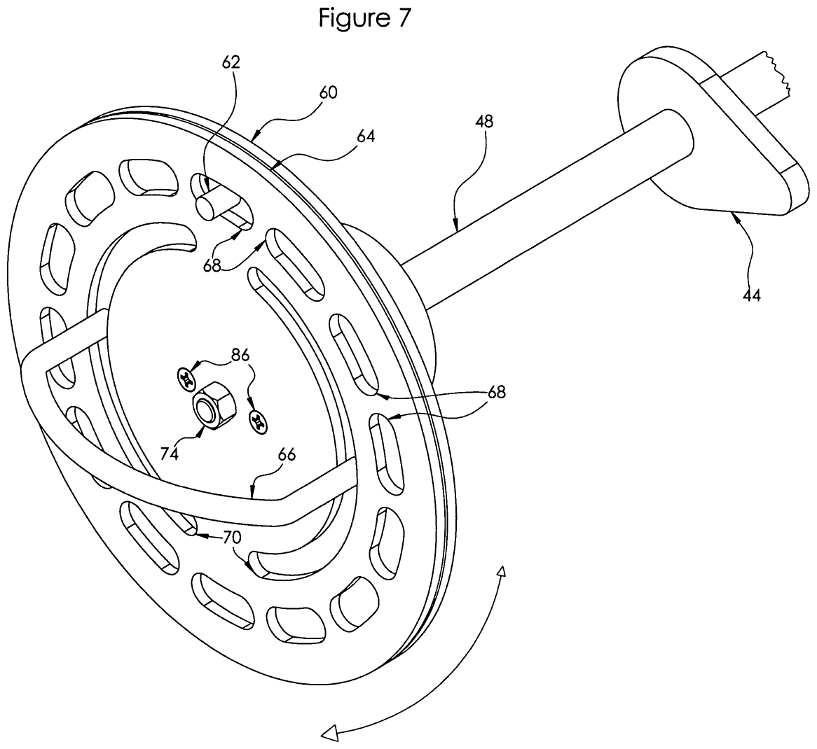

FIG. 2 indicates one convenient manner of adjustment of the angle made by the separation ramp 18 to the horizontal. The ramp 18 is pivoted at one end with respect to the structure of the separator, as indicated at 42. A plurality of aligned cams 44 are mounted on a shaft 48 for collective rotation, and bear at intervals along the length of shaft 48 against the underside of the separation ramp 18. Thus, if the shaft 48 is rotated counterclockwise in the view of FIG. 2, the angle of the ramp to the horizontal will be increased. One end of the shaft 48 will typically protrude from the housing of the separator unit, for convenience in adjustment; one useful adjustment mechanism is detailed below in connection with FIGS. 7-9. Gravity holds the ramps against the cams; additionally, one or more tension springs 46, secured between the ramp and the structure of the separator, on the underside of the ramp to prevent interference with the materials to be separated, may be provided to urge the ramp against the cams. Those of skill in the art will recognize numerous differing ways of providing adjustment of the angle of separation ramp 18; for example, similar cams could be provided at both lower and upper edges of the separation ramp to double the amount of adjustment provided. Similar cam mechanisms can be employed to adjust the angles of the preparation ramps 14 and 16.

Other parameters relevant to the separation of materials of differing mass and aerodynamic quality may likewise be readily adjusted. For example, the angle of incidence of the air stream 20 on the separation ramp 18 and its distance therefrom can be adjusted by mounting the fan 22 on a sliding, pivoting mounting structure as indicated at 50 and by arrows 52 and 54. Provision of suitable sliding and pivoting structure is within the skill of the art without specific discussion herein. Similarly, the velocity of the air stream 20 can be controlled by employment of a variable-speed fan 22. The ducting connecting the fan to the impact point 24 may also be shaped to provide desired results; for example, a wide exit orifice, narrow in the vertical dimension, may be useful.

It will be appreciated that fine-tuning the operation of the separator with respect to a typical stream of mixed materials to be separated will require experimentation, possibly simplified by the ability to watch the operation of the separator in real time, that is, as a given stream of materials is being processed. This could be accomplished by making some of the walls of the separator assembly of a transparent material, with suitable illumination provided. An operator could then observe the separation process directly, and adjust the various parameters mentioned to achieve desired results.

The vertical extent of the fall zone from the final preparation ramp 16 along a material fall path 58 will influence the rebound height of material impacting the separation ramp 18. In general, a greater “fall zone” distance, resulting in higher impact speed, will result in higher rebound. Similarly, the material composition of the ramp 18 will affect the rebound characteristics of mixed materials. In general, ramp materials that absorb more of the impact from falling objects will result in smaller rebound. Accordingly, the ramp material may be any material that provides a suitable rebound for the particular application. High-density plastic materials, such as those known in the art as HDPE (high density polyethylene), UHMW (ultra-high molecular weight polyethylene) or urethane have been found useful in prototype testing. Typically sheets of the material chosen will be affixed to steel backing plates, to enable ready replacement as the plastic material wears.

The optimal distance of the air stream 20 above the ramp impact point 24 will depend upon the rebound characteristics of the materials to be separated. In general, air stream height should be adjusted to maximize air velocity in the bounce zone 30 of the material intended to be separated to the light side 26 (see FIG. 2). For example, plastic bottle caps were found to typically rebound between 4 and 10 cm in a particular separator. Directing the air stream 20 to this region maximized transfer of these bottle caps to the light side 26. Glass, on the other hand, typically rebounded less than 6 cm. Lower air velocity within 6 cm of the impact point 24 allowed more of the glass to slide to the heavy side 28.

The angle of the air stream 20 relative to the angle of the separation ramp 18 can be adjusted to assure high velocity air at the surface of the ramp 18, beyond the material impact point 24, toward the back of the ramp 18. As indicated in FIG. 2, the point of maximum velocity air stream 20 is preferably above the impact point 24 such that the air stream contacts the ramp surface a short distance beyond the impact point 24. Accordingly, falling or bouncing materials that are deflected by the air stream 20 are likely to land on the ramp 18 beyond the impact point 24. The high air velocity at the ramp surface will increase the likelihood that the material will continue up the ramp to the light side 26 rather than slide down the ramp to the heavy side 28.

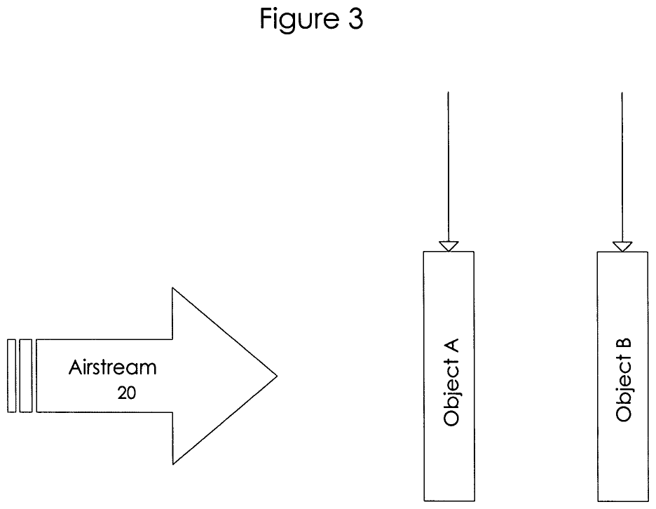

Operational problems can be caused by increasing feed rate, including blocking/entangling and bounce suppression. Blocking/entangling occurs from one falling object (Object A) getting between another falling object (Object B) and the air stream 20 (see FIG. 3). If Object A is heavy and/or has low aerodynamic drag, and Object B is light and/or has high aerodynamic drag, Object A can block the air stream 20 from entraining Object B to the light side 26 of the separator. Instead, Object B is more likely to slide down the ramp to the heavy side 28. On the other hand, if Object A is light or has high aerodynamic drag, and Object B is heavy or has low aerodynamic drag, Object A may be entrained in the air stream 20 and then impact Object B making it more likely that Object B will be displaced to the light side 26.

Bounce suppression occurs from one object falling on another object, reducing or preventing the impacted object from bouncing off the ramp. Reduced bounce will reduce the likelihood that an object will be entrained in the air stream 20 and removed to the light side 26.

The relevant feed rate of material to the separation ramp 18 is in terms of mass/unit ramp width/unit time. For example, “pounds of material per inch of ramp width per minute.” Once the feed rate for a given separator has been increased to the point that blocking/entangling and/or bounce suppression become significant, the only way to increase feed rate without causing operational problems is to make the ramp wider.

In experimentation with equipment implementing the invention, it was found that if the material to be removed to the light side 26 is relatively uniform, a single separator may be sufficient. For example, shredded paper was removed with better than 95% efficiency from recycled glass using a single separator with an air stream velocity of 1,500 feet per minute (fpm). Due to the low mass and high aerodynamic drag of shredded paper, most of the material was entrained in the air stream 20 before impacting the separation ramp 18, so that attributes such as ramp angle or distance of maximum air velocity above the impact point 8 had little effect on separation efficiency. Almost no glass was entrained with the paper on the light side 6 of the separator.

If the material to be removed has a greater range of density and aerodynamic drag, multiple separators can be used in series. For example, a second separator, following the separator described above, of similar design but operating with an air velocity of 2,000 fpm, was able to remove approximately 75% of non-glass residue (NGR) with somewhat higher density and/or lower aerodynamic drag in comparison to shredded paper from the material collected on the heavy side of the first separator. This included items such as plastic bottle caps, drinking straws, wrappers, etc.

Additional separators could be added to remove NGR with even higher density and lower aerodynamic drag (such as prescription bottles, plastic ware, small pieces of wood, etc.). However, greater air velocity is required to remove these to the light side 26 of the separator. With increasing air velocity, a greater amount of glass tends to be entrained in the air and removed to the light side 26. Modifying separator attributes that influence the bounce zone 30 can reduce or eliminate the amount of glass entrained:

Other separating equipment could also be helpful, when used in conjunction with one or more of the separators, in removing unwanted contaminants. For example, NGR often contains metal items that could be removed with a magnet or eddy current device. These items are often entrained with other NGR, such as shredded paper, making it difficult to separate the metal items. However, removing the interfering NGR using one or more separators according to the invention can make following magnetic or eddy current separators much more effective. As indicated above, the separator of the invention can be useful as a “pretreatment step” on the input side of a system for treatment of post-consumer waste, as in the Andela patent, or could be interposed in the overall system disclosed therein, for example after the metal removal steps taught therein.

FIG. 4 shows another embodiment of the separator of the invention. In this embodiment, a further baffle 32 is provided to keep the paper fluff from blowing back into the waste glass stream. Also shown in FIG. 4 is a dust filter 36 and an air plenum 38, for collecting the air stream prior to exhaust at 40. An exhaust fan or vacuum device may be useful to promote flow of lighter components of the waste stream to the light side.

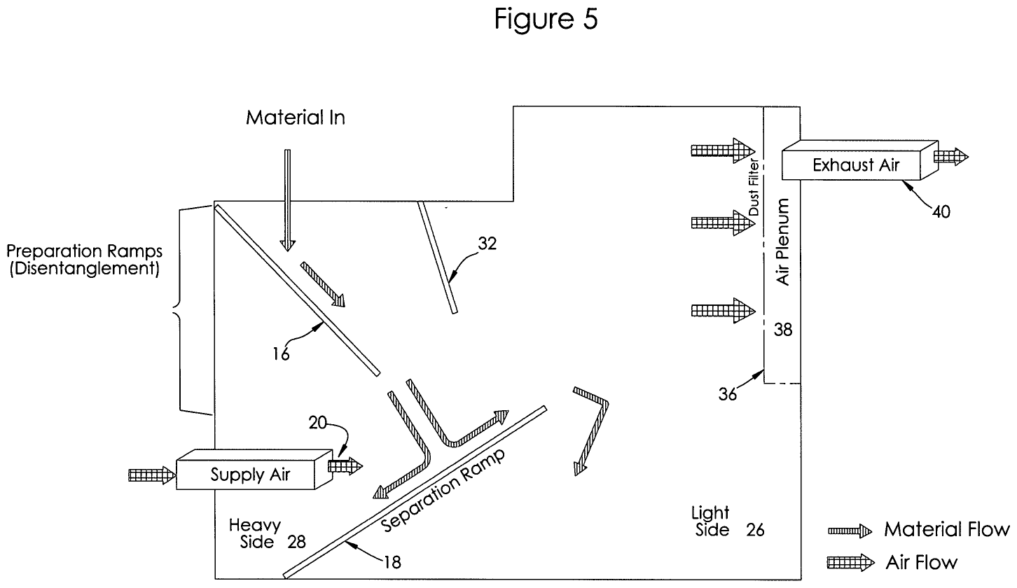

FIG. 5 shows another embodiment of the separator of the invention. In this embodiment, ramp 14 is eliminated, as may be desirable with certain material streams.

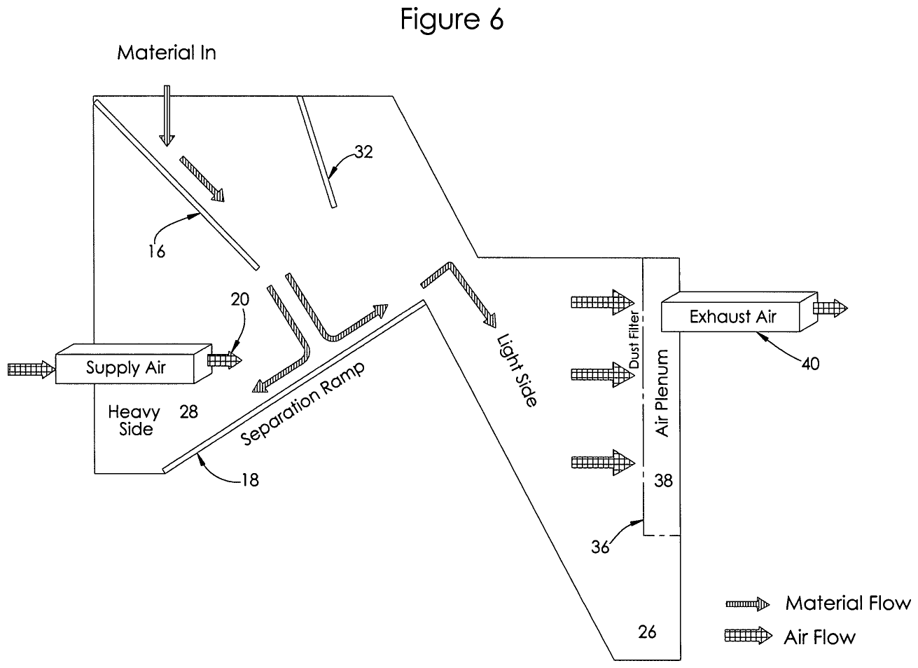

FIG. 6 shows another embodiment of the separator of the invention. In this embodiment, the light side 26 is extended downwardly, to enable collection of more material without increasing the overall height of the device.

In each embodiment, means are provided to allow the collected light and heavy materials to be withdrawn at intervals for further processing or disposal. These are not shown, but are within the skill of the art.

In a typical commercial operation, the basic steps in processing co-mingled material, primarily glass, plastic, and paper, metals having been previously removed from the waste stream by screens, magnetic or eddy-current equipment well-known to the art, might be as follows:

The co-mingled material (glass, plastic, and paper) is deposited onto a conveyor via surge hopper.

From the conveyor this material is then deposited onto a vibratory feeder which spreads the material out into a more uniform stream.

The co-mingled material enters a hood at the top of the separator unit.

The co-mingled material first slides down at least a first preparation ramp, preferably adjustable, and then falls onto a separation ramp in front of an airstream provided by a fan/blower unit.

As the co-mingled material falls in front of the airstream, the paper and light plastics are blown up and over an upper edge of the separation ramp, such that the sorted plastic and paper fall into a light zone, and can be removed through an opening on the bottom of the separation unit.

The glass falls backward down the separation ramp and into a heavy zone, and can be removed through a separate opening at the bottom of the separation unit.

Openings at the bottom of the separation unit in the light side 26 and heavy side 28 can be arranged to feed the collected materials into, for example, tip bin hoppers or onto conveyors.

Preferably, both the preparation and separation ramps are adjustable, for example by separate cam mechanisms controlled from the exterior of the separation unit.

FIGS. 7-9 show one possible mechanism for rotating the shaft 48 to adjust the position of the cams 44 to desired radial locations, and thus to control the angle made by the separation ramp 18 to the horizontal. Other suitable mechanisms are within the skill of the art.

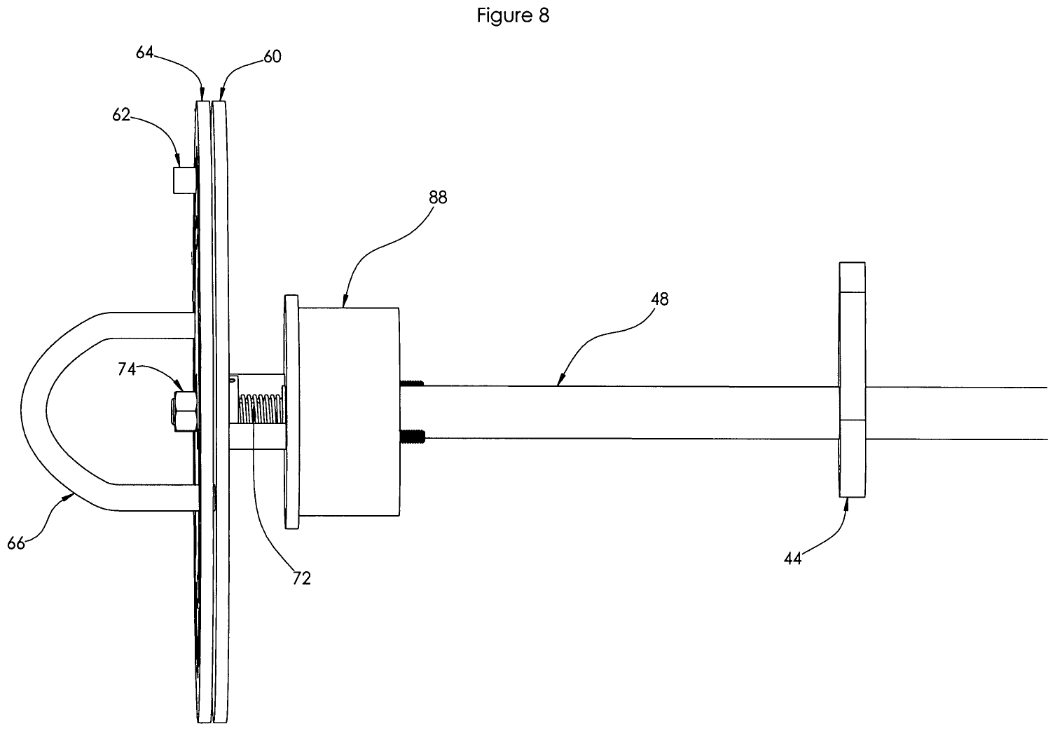

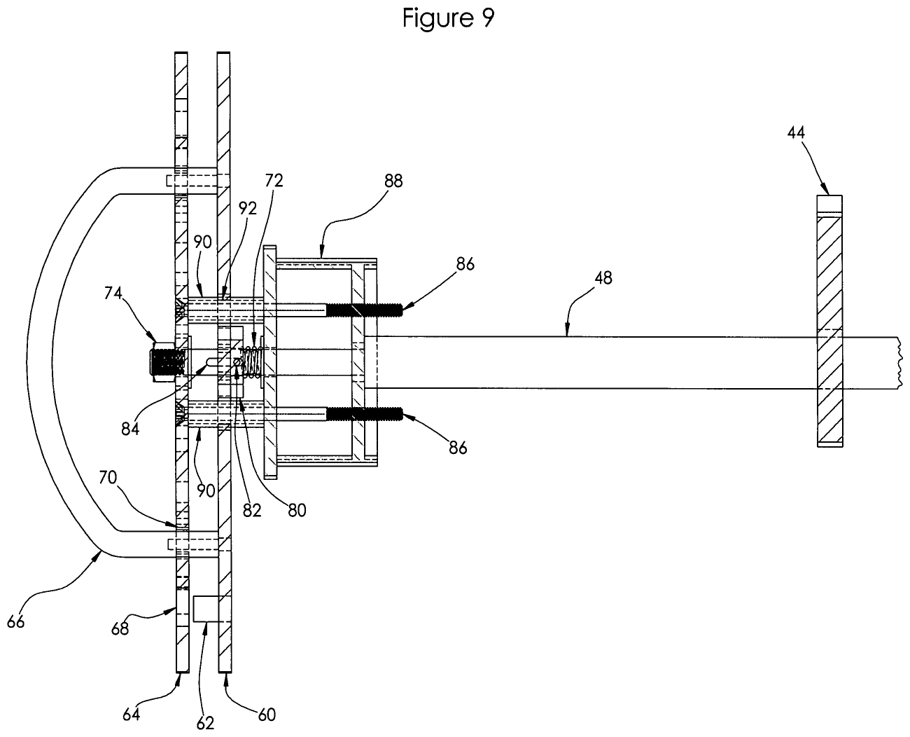

FIG. 7 shows a perspective view of the mechanism, FIG. 8 an elevation, and FIG. 9 a cross-sectional view, comparable to FIG. 8, but taken at a different angle. A location disc 60 having an indexing pin 62 affixed thereto is secured to shaft 48, so that as location disc 60 is rotated, the cams 44 are turned, and the angle of separation ramp 18 to the horizontal is adjusted. A handle 66 is secured to location disc 60 for convenient adjustment. In order to secure location disc 60 in a desired radial position, pin 62 protrudes though one of a plurality of curved slots 68 in a second indexing disc 64, fixed to the separator housing. Handle 66 similarly protrudes through curved slots 70 in indexing disc 64. Shaft 48 is secured to location disc 60 by a nut 74; indexing disc 64 thus supports shaft 48 at this end, while the other end of shaft 48 can simply protrude though the opposing wall of separator housing 10 (see FIG. 1) and be secured in place by a similar nut (not shown).

Location disc 60 is secured radially to shaft 48, but can slide linearly therealong for a short distance, rightwardly from the position of FIG. 8 to reach the position shown in FIG. 9, in which pin 62 is disengaged from slot 68 in indexing disc 64. This allows location disc 60 to be rotated, adjusting the cams 44. A compression spring 72 biases disc 60 leftwardly in FIG. 8, so that pin 62 secures the position of location disc 60 except when adjustment is required. Thus, when adjustment is required, an operator simply pushes on handle 66 against the bias of spring 72, so that pin 62 is moved out of engagement with slot 68, and rotates the assembly of location disc 60, shaft 48, and cam 44 to the desired position, and releases handle 66, so that pin 62 fits into a different slot 68, securing the assembly against further rotation.

FIG. 9 shows the details of the mechanism whereby location disc 60 can be moved laterally along shaft 48 while being fixed radially thereto. A collar 80 is welded to the location disc 60, and receives a bolt 82 sliding in a slot 84 in shaft 49. Bolts 86 secure indexing disc 64 to support structure 88, which assists in supporting shaft 48. Standoffs 90 space structure 88 from indexing disc 64, and pass through slots 92 in location disc 60.

While a preferred embodiment of the invention has been discussed in detail, the invention should not be limited thereby, but only by the following claims.

What is claimed is:

1. Apparatus for the separation of a stream of mixed materials, said mixed materials including a first class of materials of lesser density and greater air resistance and a second class of materials of greater density and lesser air resistance, said apparatus comprising:
a housing having an entry portal on its upper surface, for receiving said stream of mixed materials;
at least a first preparation ramp, mounted at an angle to the horizontal, such that said stream of mixed materials impacts said first preparation ramp and slides downwardly along a surface thereof;
a separation ramp, mounted at an angle to the horizontal beneath said first preparation ramp; and
a source of pressurized air, providing an air stream directed at said separation ramp so that said first class of materials of lesser density and greater aerodynamic drag are blown up said separation ramp and over a rear edge thereof, for collection in a light side portion at a bottom of said housing, while said second class of materials of greater density and lesser aerodynamic drag descend said separation ramp and fall off a forward edge thereof for collection in a heavy side portion at the bottom of said housing.

2. The apparatus of claim 1, wherein said source of pressurized air is aimed at said separation ramp such that the bulk of the air stream is located vertically above the point at which the stream of mixed materials impacts the separation ramp.

3. The apparatus of claim 1, wherein the angle made by the separation ramp to the horizontal is adjustable.

4. The apparatus of claim 1, wherein the angle of incidence of the air stream on the separation ramp is adjustable.

5. The apparatus of claim 1, wherein the velocity of the air stream is adjustable.

6. The apparatus of claim 1, comprising a second preparation ramp.

7. The apparatus of claim 1, wherein transparent panels are provided in said housing, to permit observation of the separation process.

8. The apparatus of claim 1, wherein the surface material of said separation ramp is chosen from the group consisting of HDPE (high density polyethylene), UHMW (ultra-high molecular weight polyethylene) and urethane.

9. A method for the separation of a stream of mixed materials, said mixed materials including a first class of materials of lesser density and greater aerodynamic drag and a second class of materials of greater density and lesser aerodynamic drag, said method comprising the following steps:
providing a separator, said separator comprising:
a housing having an entry portal on its upper surface,
at least a first preparation ramp, mounted at an angle to the horizontal,
a separation ramp, mounted at an angle to the horizontal beneath said first preparation ramp; and
a source of pressurized air, providing an air stream directed at said separation ramp;
dispensing said stream of mixed materials into said entry portal, such that said stream of mixed materials impacts said first preparation ramp and slides downwardly along a surface thereof, and falls thence onto said separation ramp; and
employing said stream of air to separate said steam of materials, such that said first class of materials of lesser density and greater aerodynamic drag are blown up said separation ramp and over a rear edge thereof, for collection in a light side portion of a bottom of said housing, while said second class of materials of greater density and lesser aerodynamic drag descend said separation ramp and fall off a forward edge thereof for collection in a heavy side portion of the bottom of said housing.

10. The method of claim 9, wherein said source of pressurized air is aimed at said separation ramp such that the bulk of the air stream is located vertically above the point at which the stream of mixed materials impacts the separation ramp.

11. The method of claim 9, wherein the angle made by the separation ramp to the horizontal is adjustable.

12. The method of claim 9, wherein the angle of incidence of the air stream on the separation ramp is adjustable.

13. The method of claim 9, wherein the velocity of the air stream is adjustable.

14. The method of claim 9, wherein a second preparation ramp is provided.

15. The method of claim 9, wherein transparent panels are provided in said housing, to permit observation of the separation process.

16. The method of claim 9, wherein the surface material of said separation ramp is chosen from the group consisting of HDPE (high density polyethylene), UHMW (ultra-high molecular weight polyethylene) and urethane.
